(19) United States
(12) Patent Application Publication
(10) Pub. No.: US 2017/0257815 A1
(43) Pub. Date: Sep. 7, 2017

(54) MOBILE-TERMINAL-BASED TIME ZONE DETERMINATION METHOD AND MOBILE TERMINAL

(71) Applicants: LE HOLDINGS (BEIJING) CO., LTD., Beijing (CN); Lemobile Information Technology (Beijing) Co., Ltd., Beijing (CN)

(72) Inventor: Tiancheng TONG, Beijing (CN)

(21) Appl. No.: 15/249,933

(22) Filed: Aug. 29, 2016

Related U.S. Application Data
(63) Continuation of application No. PCT/CN2016/089358, filed on Jul. 8, 2016.

(30) Foreign Application Priority Data
Mar. 7, 2016 (CN) 201610128604.3

(51) Int. Cl. H04W 48/04; H04B 1/3816; H04B 1/3827

(52) U.S. Cl. CPC H04W 48/04; H04B 1/3827; H04B 1/3816; H04W 88/02

(57) ABSTRACT

An embodiment of the present disclosure discloses a mobile-terminal-based time zone determination method and a mobile terminal, wherein the method comprises: determining if first zone information of a mobile terminal is acquired, wherein the first time zone information is time zone information, which is acquired through a user ID card of the mobile terminal; acquiring longitude and latitude information of the mobile terminal if the first time zone information is not acquired; determining second time zone information corresponding to the longitude and latitude information; and defining the second time zone information as the current time zone information of the mobile terminal when the second time zone information is inconsistent with the time zone information currently displayed by the mobile terminal. The present disclosure greatly enhances convenience and accuracy of time confirmation of a user in the case that the SIM card does not exist or is unavailable.

### CROSS-REFERENCE TO RELATED APPLICATIONS

This application is a continuation of International Application NO. PCT/CN2016/089358 filed on Jul. 8, 2016, which is based upon and claims priority to Chinese Patent Application No. 201510128604.3, entitled “MOBILE-TERMINAL-BASED TIME ZONE DETERMINATION METHOD AND MOBILE TERMINAL”, filed Mar. 7, 2016, the entire contents of all of which are incorporated herein by reference.

### TECHNICAL FIELD

The present disclosure generally relates to the technical field of mobile terminals, in particular to a mobile-terminal-based time zone determination method and a mobile terminal for time zone determination.

### BACKGROUND

Along with popularization of mobile terminals, more and more users use mobile terminals to confirm time. Automatic time setting in the mobile terminals has become an important function of the mobile terminals. In the time setting function of the mobile terminals, time zone setting plays a key role. If the time zone setting is wrong, the displayed time will be wrong.

In the prior art, the mobile terminal can use an NITZ (Network Identity and Time Zone) mechanism to automatically configure local time and date. The NITZ acquires time zone information through an operator, which means that, in order to achieve a correct time zone, the mobile terminal must be inserted with an SIM card, and the SIM card is in the available mode; otherwise, synchronization of the time zone fails. For example, when a Chinese user is in a foreign country, the local time zone may be different from the time zone of Beijing; and if the user does not open the international roaming option (which means that the SIM card is unavailable in foreign country), and then the function of automatically synchronizing the time zone cannot be used.

### SUMMARY

An embodiment of the present disclosure discloses a mobile-terminal-based time zone determination method and a mobile terminal to solve the problem that an automatic time zone synchronization function cannot he used because an SIM card is unavailable or does not exist in the prior art.

According to an embodiment of the present disclosure, there is provided a mobile-terminal-based time zone determination method, comprising:
determining whether first zone information of a mobile terminal is acquired, wherein the first time zone information is time zone information, which is acquired through a user ID card of the mobile terminal;
if not acquiring the first time zone information, acquiring longitude and latitude information of the mobile terminal;
determining second time zone information corresponding to the longitude and latitude information;
and defining the second time zone information as the current time zone information of the mobile terminal when the second time zone information is inconsistent with the time zone information currently displayed by the mobile terminal.

According to an embodiment of the present disclosure, there is provided a mobile terminal for time zone determination, comprising: at least one processor; and a memory communicably connected with the at least one processor for storing instructions executable by the at least one processor, wherein execution of the instructions by the at least one processor causes the at least one processor to:
determine whether first zone information of a mobile terminal is acquired, wherein the first time zone information is time zone information, which is acquired through a user ID card of the mobile terminal;
acquire longitude and latitude information of the mobile terminal if the first time zone information is not acquired;
determine second time zone information corresponding to the longitude and latitude information;
take the second time zone information as the current time zone information of the mobile terminal when the second time zone information is inconsistent with the time zone information currently displayed by the mobile terminal.

According to an embodiment of the present disclosure, there is provided a computer program, comprising computer readable codes, wherein the computer readable codes run on a mobile terminal so that the mobile terminal executes any one mobile-terminal-based time zone determination method above.

According to an embodiment of the present disclosure, there is provided a computer readable medium storing the computer program above.

The embodiment of the present disclosure provides a mobile-terminal-based time zone determination method and a mobile terminal. When the first time zone information, aiming at a user ID card, of the mobile terminal is incapable of being acquired, the current longitude and latitude information of the mobile terminal is further acquired, while the second time zone information corresponding to the longitude and latitude information is determined; and, when the second time zone information is inconsistent with the time zone information currently displayed by the mobile terminal, the second time zone information is taken as the current time zone information of the mobile terminal. When the mobile terminal is not inserted with the SIM card or the SIM card is unavailable, the present disclosure can accurately acquire the time zone information of the mobile terminal and realize the automatic synchronization of a time zone, greatly enhancing convenience and accuracy of time confirmation of a user in the case that the SIM card does not exist or is unavailable.

### BRIEF DESCRIPTION OF THE DRAWINGS

To clearly describe the technical solution in the embodiments of the present disclosure or in the prior art, the following are brief introduction of the attached drawings used to describe the technology in the embodiments or in the prior art. Obviously, the attached drawings described below involve some embodiments of the present disclosure. For a person skilled in the art, other drawings can be made according to those drawings without creative labor.

FIG. 1 is a step flowchart of a mobile-terminal-based time zone determination method according to an embodiment of the present disclosure.

FIG. 2 is a structural block diagram of a mobile terminal for time zone determination according to an embodiment of the present disclosure.

FIG. 3 schematically illustrates a block diagram of a mobile terminal for executing the method according to the present disclosure.

FIG. 4 schematically illustrates a memory cell for holding or carrying program codes for realizing the method according to the present disclosure.

### DESCRIPTION OF THE EMBODIMENTS

To clarify the objectives, technical solutions and advantage of the embodiments of the present disclosure, the technical solutions in embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, a person skilled in the art can obtain other embodiments without creative labor, which shall all fall within the protection scope of the present disclosure.

Refer to FIG. 1, which is a step flowchart of a mobile-terminal-based time zone determination method according to an embodiment of the present disclosure. The method can specifically include the following steps.

Step 101: determining if the first time zone information of the mobile terminal is acquired.

Specifically, a time zone is a zone, in which the same time is used, on earth. The whole earth is divided into 24 time zones (12 time zones in each of the east and west semi-spheres). It is specified that Greenwich Observatory in the UK is the mean time zone (zero time zone), namely GMT (Greenwich Mean Time), and the east 12 zones are superposed with the west 12 zones. Each time zone crosses a 15° span of longitude, and the time interval is just 1 h. The time in the central longitude of each time zone is the time uniformly used in this time zone, called zone time. The time difference between two adjacent time zones is 1 h. For example, the time of the eighth east zone in China is always 1 h faster than the time of the seventh east zone in Thailand, but 1 h later then the ninth east zone in Japan.

Applied to the embodiment of the present disclosure, the first time zone information can be the time zone information acquired through the user ID card of the mobile terminal. As an example, the user ID card can include an SIM (Subscriber Identity Module) card, etc.

In specific realization, a digital mobile phone with GSM (Global System for Mobile Communication) is available only after being inserted with the SIM card, and a chip in the SIM card stores information of digital mobile phone clients, encrypted key, user's contact list, etc., which can be identified by the GMS network clients, and can encrypt the voice information during communication with clients.

In an optimal embodiment of the present disclosure, the step 101 can also include the following sub-steps:
sub-step S11: acquiring a callback function of a monitoring program pre-set in the mobile terminal, wherein the callback function includes telephone service related parameters;
sub-step S12: determining if the telephone service related parameters include the time zone information; if so, determining that the first time zone information of the mobile terminal is capable of being acquired; and if not, determining that the first time zone information of the mobile terminal is incapable of being acquired.

In the embodiment of the present disclosure, aiming at the “Setting” function of the mobile terminal, an [automatic time zone synchronization] switch can be set in a UI (User Interface) design of Setting (for example, the opening route of the function can be [Setting]-[Date and Time]-[automatic time zone synchronization]); and in a time zone field can be newly added into a Setting database, for example, Settings.XXX.AUTO_TIM_ZONE. The newly added time zone field can be used for storing the value of the [automatic time zone synchronization] switch, for example, 1 represents that a user switches on the [automatic time zone synchronization], and 0 represents that the user does not switch on the [automatic time zone synchronization].

Meanwhile, a monitoring program (for example, database Observer) can be set. The monitoring program can be used for monitoring changes of a time zone field Settings.XXX.AUTO_TIM_ZONE, for example, when the value of the field Settings.XXX.AUTO_TIM_ZONE changes from 0 to 1, this means that a user turns on the [automatic time zone synchronization] switch, and then the database observer can monitor the switching event.

When a user turns on the [automatic time zone synchronization] switch in the mobile terminal, the monitoring program monitors the time zone field Settings.XXX.AUTO _TIM_ZONE and feeds back a callback function. The callback function can include telephone service related parameters, for example, the callback function of the database Observer can include an XXXServiceTracker approach on a Telephony side; the XXXServiceTracker can include time zone information; if the XXXServiceTracker includes time zone information, it represents that the time zone information can be acquired through the SIM card, wherein the time zone information is the first time zone information; and if the XXXServiceTracker does not include the time zone information, it represents that the time zone information cannot be acquired through the SIM card.

In actual application, if the SIM card cannot acquire the time zone information, it is represented that the mobile terminal does not have the SIM card or the SIM card is faulty or unavailable. As an example, the cases that the SIM card is unavailable include: the mobile terminal of a user roams in foreign countries while the internal roaming function of the SIM card is not enabled, so the SIM is unavailable.

In actual realization, if the mobile terminal can acquire the first time zone information, the first time zone information can be compared with the time zone information locally displayed by the mobile terminal; if the first time zone information is inconsistent with the time zone information locally displayed by the mobile terminal, and then in the mobile terminal, the current time zone information of the mobile terminal can be set as the first time zone information.

Step 102: acquiring longitude and latitude information of the mobile terminal if the first time zone information is not acquired.

If the mobile terminal cannot acquire the first time zone information, meaning that the mobile terminal does not have the SIM card or the SIM card is unavailable, the current longitude information and latitude information of the mobile terminal can be further acquired (namely longitude and latitude information).

In an optimal embodiment of the present disclosure, the step 102 can also include the following sub-steps:
sub-step S21: if the first time zone information is not acquired, determining if a wireless network connection of the mobile terminal is enabled, and when it is determined that the wireless network connection is not enabled, enabling the wireless network connection;
sub-step S22: acquiring the current longitude and latitude information of the mobile terminal by using a network positioning function of the mobile terminal.

When it fails to acquire the first time zone information through the SIM card, it is can be determined if the mobile terminal has enabled the wireless network connection; and if it is determined that the mobile terminal does not enable the wireless network connection, then, the wireless network connection of the mobile terminal is enabled, for example, the WIFI connection of the mobile network is enabled, and the current longitude and latitude information of the mobile terminal is acquired through the network positioning function.

In specific realization, after the wireless network connection of the mobile terminal is enabled, a positioning interface xxx-locate in the mobile terminal can be called, and the network positioning function is used to acquire the current longitude and latitude information of the mobile terminal.

Step 103: determining second time zone information corresponding to the longitude and latitude information.

After the current longitude and latitude information of the mobile terminal is acquired, the second time zone information corresponding to the longitude and latitude information can be further determined according to the longitude and latitude information.

In an optimal embodiment of the present disclosure, the step 103 can also include the following sub-steps:
sub-step S31: uploading the longitude and latitude information to a server so that the server determines a geographic position of the mobile terminal according to the longitude and latitude information, and determines the second time zone information of the mobile terminal according to the geographic position;
sub-step S32: receiving the second time zone information fed back by the server.

Specifically, the mobile terminal can upload the longitude and latitude information to the server after acquiring the current longitude and latitude information. On the server side, the server can determine the geographic position of the mobile terminal according to the received longitude and latitude information, obtain the second time zone information at the position where the mobile terminal locates according to the geographic information, and feeds the second time zone information back to the mobile terminal.

For example, the server can obtain that the corresponding geographic position is Beijing through conversion of the current longitude and latitude information of the mobile terminal, and obtains that the time zone corresponding to Beijing is the eighth east zone.

It should be noted that, after acquiring the current longitude and latitude information, the mobile terminal can also select not to upload the longitude and latitude information to the server, but determine the geographic position of the mobile terminal according to the longitude and latitude information at a local position, and obtains the second time zone corresponding to the geographic position according to the locally stored relationship between positions and time zones.

Step 104: defining the second time zone information as the current time zone information of the mobile terminal when the second time zone information is inconsistent with the time zone information currently displayed by the mobile terminal.

After the mobile terminal obtains the current second time zone information of the mobile terminal, the second time zone information can be compared with the time zone information locally displayed by the mobile terminal; if the second time zone information is inconsistent with the time zone information locally displayed by the mobile terminal, and then in the mobile terminal, the current time zone information of the mobile terminal can be set as the second time zone information.

After the current time zone information of the mobile terminal is determined, the local time of the position where the mobile terminal locates can be determined according to the time zone information.

For example, if the current time zone information of the mobile terminal is the second time zone information, the local time of the position where the mobile terminal locates can be determined according to the second time zone information. Or, if the current time zone information of the mobile terminal is the first time zone information, the local time of the position where the mobile terminal locates can be determined according to the first time zone information.

In the specific realization, local time is a time standard taking the meridian line of a position where an observer stands as the reference point, reflecting the natural time. For example, in China, the time of the eighth east zone where the capital Beijing is taken as the nationwide uniform time, called Beijing Time, namely GMT time+8 H=Beijing time.

In the embodiment of the present disclosure, when the first time zone information of the mobile terminal is incapable of being acquired, the current longitude and latitude information of the mobile terminal is further acquired, while the second time zone information corresponding to the longitude and latitude information is determined; and, when the second time zone information is inconsistent with the time zone information currently displayed by the mobile terminal, the second time zone information is taken as the current time zone information of the mobile terminal. When the mobile terminal is not inserted with the SIM card or the SIM card is unavailable, the present disclosure can accurately acquire the time zone information of the mobile terminal and realize the automatic synchronization of a time zone, greatly enhancing convenience and accuracy of time confirmation of a user in the case that the SIM card does not exist or is unavailable.

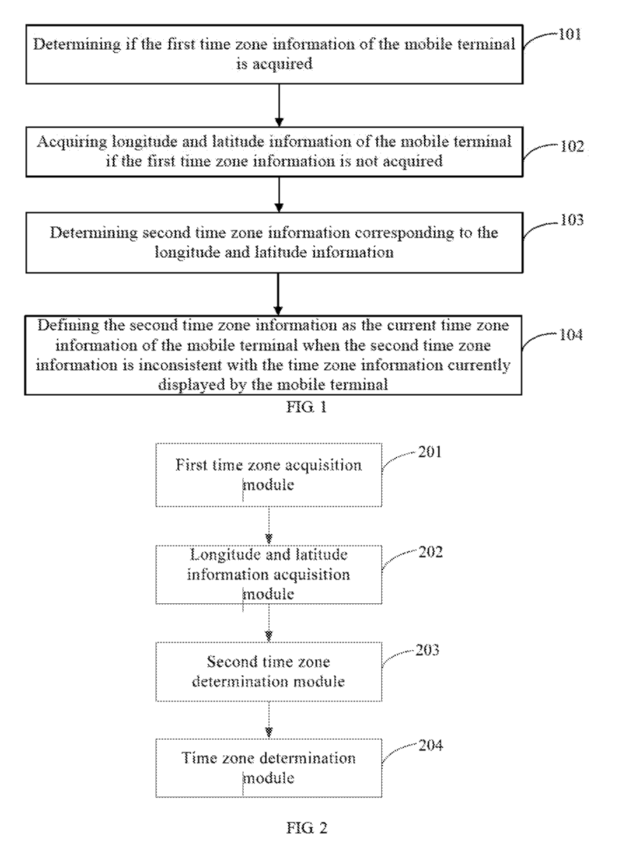

Refer to FIG. 2, which illustrates a structural block diagram of a mobile terminal for time zone determination according an embodiment of the present disclosure, wherein, in the embodiment of the present disclosure, related functions modules are achieved through a hardware processor, specifically including the following:
a first time zone acquisition module 201, used for determining if first zone information of a mobile terminal is acquired, wherein the first time zone information is time zone information, which is acquired through a user ID card of the mobile terminal;
a longitude and latitude information acquisition module 202, used for acquiring longitude and latitude information of the mobile terminal if the first time zone information is not acquired;
a second time zone information determination module 203, used for determining second time zone information corresponding to the longitude and latitude information;
and a time zone determination module 204, used for defining the second time zone information as the current time zone information of the mobile terminal when the the second time zone information is inconsistent with the time zone information currently displayed by the mobile terminal.

In an optimal embodiment of the present disclosure, the mobile terminal can also include the following modules:
a local time determination module, used for determining local time of a position where the mobile terminal locates according to the second time zone information.

In an optimal embodiment of the present disclosure, the first time zone acquisition module 201 can include the following sub-modules:
a callback function acquisition sub-module, used for acquiring a callback function of a monitoring program pre-set in the mobile terminal, wherein the callback function includes telephone service related parameters;
and a determination sub-module, used for determining if the telephone service related parameters include the time zone information; if yes, determining that the first time zone information of the mobile terminal is capable of being acquired; and if not, determining that the first time zone information of the mobile terminal is incapable of being acquired.

In an optimal embodiment of the present disclosure, the longitude and latitude information acquisition module 202 can include the following sub-modules:
a network enabling sub-module, used for, if the first time zone information is not acquired, determining if a wireless network connection of the mobile terminal is enabled, and when it is determined that the wireless network connection is enabled, enabling the wireless network connection;
and a longitude and latitude information determination sub-module, used for acquiring the current longitude and latitude information of the mobile terminal by using a network positioning function of the mobile terminal.

In an optimal embodiment of the present disclosure, the second time zone determination module 203 can include the following sub-modules:
a longitude and latitude information uploading sub-module, used for uploading the longitude and latitude information to a server so that the server determines a geographic position of the mobile terminal according to the longitude and latitude information, and determines the second time zone information of the mobile terminal according to the geographic position;
and a second time zone information receiving sub-module, used for receiving the second time zone information fed back by the server.

The mobile terminal embodiment in FIG. 2, and basically similar to the above method embodiment and therefore is simply described. Related contents can be seen in the related description of the method embodiments.

The mobile terminal embodiment described above is merely schematic, wherein units described as separable parts may be or may be not physically separated, and components displayed as units may be or may be not physical units, which means that the units can be positioned at one place or distributed on a plurality of network units. Some or all modules can be selected to fulfill the objective of the solution in the embodiment upon actual demands. A person skilled in the art can understand and implement the present disclosure without creative work.

Through the description of the above embodiments, a person skilled in the art can clearly know that the embodiments can be implemented by software and necessary universal hardware platforms, or by hardware. Based on this understanding, the above solutions or contributions thereof to the prior art can be reflected in form of software products, and the computer software products can be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

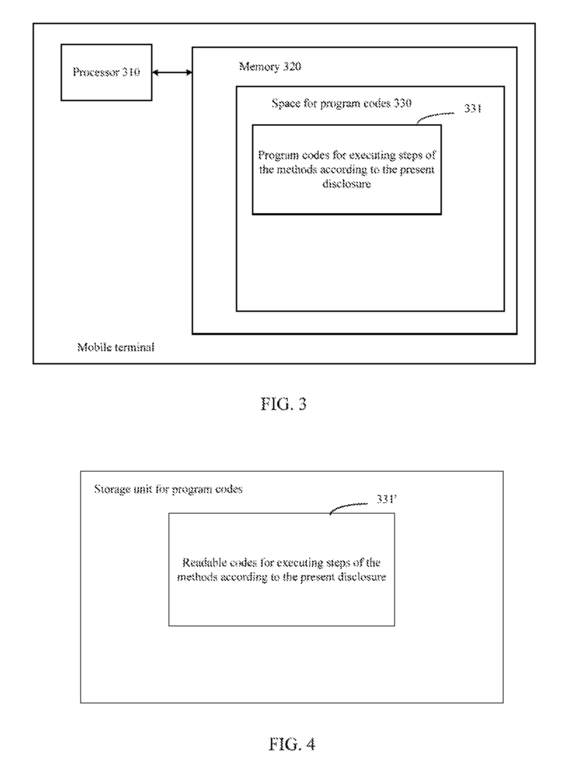

For example, FIG. 3 illustrates a block diagram of a mobile terminal for executing the method according the disclosure. Traditionally, the mobile terminal includes a processor 310 and a computer program product or a computer readable medium in form of a memory 320. The memory 320 could be electronic memories such as flash memory, EEPROM (Electrically Erasable Programmable Read-Only Memory), EPROM, hard disk or ROM. The memory 320 has a memory space 330 for executing program codes 331 of any steps in the above methods. For example, the memory space 330 for program codes may include respective program codes 331 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 4. The memory cells may be provided with memory sections, memory spaces, etc., similar to the memory 320 of the server as shown in FIG. 3. The program codes may be compressed for example in an appropriate form. Usually, the memory cell includes computer readable codes 331′ which can be read for example by processors 310. When these codes are operated on the server, the server may execute respective steps in the method as described above.

Finally, it should be noted that the above embodiments are merely used to describe instead of limiting the technical solution of the present disclosure; although the above embodiments describe the present disclosure in detail, a person skilled in the art shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A mobile-terminal-based time zone determination method, comprising:
determining whether the first zone information of a mobile terminal is acquired, wherein the first time zone information is time zone information, which is acquired through a user ID card of the mobile terminal;
if not acquiring the first time zone information, acquiring longitude and latitude information of the mobile terminal;
determining the second time zone information corresponding to the longitude and latitude information;
and defining the second time zone information as the current time zone information of the mobile terminal when the second time zone information is inconsistent with the time zone information currently displayed by the mobile terminal.

2. The method according to claim 1, further comprising:
determining local time of a position where the mobile terminal locates according to the second time zone information.

3. The method according to claim 1, wherein, the step of determining if the first time zone information of the mobile terminal is acquired comprises:
acquiring a callback function of a monitoring program pre-set in the mobile terminal, wherein the callback function comprises telephone service related parameters;
determining if the telephone service related parameters comprise the time zone information;
if yes, determining that the first time zone information of the mobile terminal is capable of being acquired;
and if not, determining that the first time zone information of the mobile terminal is incapable of being acquired.

4. The method according to claim 1, wherein, the step of acquiring the longitude and latitude information of the mobile terminal if the first time zone information is not acquired comprises:
if the first time zone information is not acquired, determining a wireless network connection of the mobile terminal is enabled, and when it is determined that the wireless network connection is not enabled, enabling the wireless network connection;
and acquiring the current longitude and latitude information of the mobile terminal by using a network positioning function of the mobile terminal.

5. The method according to claim 4, wherein, the step of determining the second time zone information corresponding to the longitude and latitude information comprises:
uploading the longitude and latitude information to a server so that the server determines a geographic position of the mobile terminal according to the longitude and latitude information, and determining the second time zone information of the mobile terminal according to the geographic position;
and receiving the second time zone information fed back by the server.

6. A mobile terminal for time zone determination, comprising:
at least one processor; and
a memory communicably connected with the at least one processor for storing instructions executable by the at least one processor, wherein execution of the instructions by the at least one processor causes the at least one processor to:
determine whether first zone information of a mobile terminal is acquired, wherein the first time zone information is time zone information, which is acquired through a user ID card of the mobile terminal;
acquire longitude and latitude information of the mobile terminal if the first time zone information is not acquired;
determine second time zone information corresponding to the longitude and latitude information;
taking the second time zone information as the current time zone information of the mobile terminal when the second time zone information is inconsistent with the time zone information currently displayed by the mobile terminal.

7. The mobile terminal according to claim 6, wherein execution of the instructions by the at least one processor causes the at least one processor to further:
determine local time of a position where the mobile terminal locates according to the second time zone information.

8. The mobile terminal according to claim 6, wherein, determine whether first zone information of a mobile terminal is acquired comprises:
acquire a callback function of a monitoring program pre-set in the mobile terminal, wherein the callback fluid comprises telephone service related parameters;
determine whether the telephone service related parameters comprise the time zone information; if yes, determine that the first time zone information of the mobile terminal is capable of being acquired; and if not, determine that the first time zone information of the mobile terminal is incapable of being acquired.

9. The mobile terminal according to claim 6, wherein, acquire longitude and latitude information of the mobile terminal if the first time zone information is not acquired comprises:
if the first time zone information is not acquired, determine if a wireless network connection of the mobile terminal is enabled, and when it is determined that the wireless network connection is not enabled, enable the wireless network connection;
acquire the current longitude and latitude information of the mobile terminal by using, a network positioning function of the mobile terminal.

10. The mobile terminal according to claim 9, wherein, determine second time zone information corresponding to the longitude and latitude information comprises:
upload the longitude and latitude information to a server so that the server determines a geographic position of the mobile terminal according to the longitude and latitude information, and determine the second time zone information of the mobile terminal according to the geographic position;
receive the second time zone information fed back by the server.

11. A non-transitory computer readable medium storing executable instructions that, when executed by a mobile terminal, cause the mobile terminal to:
determine whether first zone information of a mobile terminal is acquired, wherein the first time zone information is time zone information, which is acquired through a user ID card of the mobile terminal;
acquire longitude and latitude information of the mobile terminal if the first time zone information is not acquired;
determine second time zone information corresponding to the longitude and latitude information;
take the second time zone information as the current time zone information of the mobile terminal when the second time zone information is inconsistent with the time zone information currently displayed by the mobile terminal.

12. The non-transitory computer readable medium according to claim 11, wherein the mobile terminal is further caused to:
determine local time of a position where the mobile terminal locates according to the second time zone information.

13. The non-transitory computer readable medium according to claim 11, wherein, determine whether first zone information of a mobile terminal is acquired comprises:
acquiring a callback function of a monitoring program pre-set in the mobile terminal, wherein the callback function comprises telephone service related parameters;
determining whether the telephone service related parameters comprise the time zone information; if yes, determining that the first time zone information of the mobile terminal is capable of being acquired; and if not, determining that the first time zone illumination of the mobile terminal is incapable of being acquired.

14. The non-transitory computer readable medium according to claim 11, wherein, acquire longitude and latitude information of the mobile terminal if the first time zone information is not acquired comprises:
if the first time zone information is not acquired, determining if a wireless network connection of the mobile terminal is enabled, and when it is determined that the wireless network connection is not enabled, enabling the wireless network connection;
acquiring the current longitude and latitude information of the mobile terminal by using a network positioning function of the mobile terminal.

15. The non-transitory computer readable medium according to claim 14, wherein, determine second time zone information corresponding to the longitude and latitude information comprises:
uploading the longitude and latitude information to a server so that the server determines a geographic position of the mobile terminal according to the longitude and latitude information, and determining the second time zone information of the mobile terminal according to the geographic position;
receiving the second time zone information fed back by the server.
